(19) United States
(12) Patent Application Publication
(10) Pub. No.: US 2025/0207621 A1
(43) Pub. Date: Jun. 26, 2025

(54) WASHER AND METHOD OF PROVIDING ANCHORAGE

(71) Applicant: Illinois Tool Works Inc., Glenview, IL (US)

(72) Inventors: Lachlan Lingard Hick, Melbourne (AU); Joshua David Trezise, Melbourne (AU)

(21) Appl. No.: 18/986,029

(22) Filed: Dec. 18, 2024

(30) Foreign Application Priority Data
Dec. 21, 2023 (AU) 2023904183
Dec. 18, 2024 (AU) 2024278553

(51) Int. Cl. F16B 31/02

(52) U.S. Cl. CPC F16B 31/028

(57) ABSTRACT

A washer for filling of an annular gap around a fastener, wherein the washer has a port for filling said gap through the washer, and wherein the washer has an indicator for indicating when said gap has been sufficiently filled. A method of providing anchorage including the steps of: using an elongated fastener to anchor a first part to a second part; installing a washer as claimed in claim one; tightening the elongated fastener against the washer; feeding a chemical filler into the port of the washer to fill an annular gap around the elongated fastener; and using the indicator of the washer to determine when to stop feeding of the chemical filler.

### PRIORITY CLAIM

This application claims priority to and the benefit of Australian Patent Application No. 2023904183, filed Dec. 21, 2023, and Australian Patent Application No. 2024278553, filed Dec. 18, 2024, the entire contents of each of which are incorporated herein by reference.

### FIELD

The present disclosure relates generally to a washer and, more specifically but not exclusively to an annular gap filling washer for use in construction.

### BACKGROUND

It is known to use a washer referred to as a “filling washer” for increasing shear load capacity in construction anchorage. More specifically, it is known to anchor a first part to a second part using an elongated anchor/fastener, and filling an annular gap around the elongated fastener with a chemical anchor. The chemical anchor may be applied into the gap after tightening of the elongated fastener, by way of a port formed in the washer. Such use of filling washers may enable anchors to bear equal shear loads, providing improved strength for multiple anchor connections. In addition, the filling washers may improve seismic and dynamic performance of connections, particularly in areas which may be subject to earthquakes.

However, the applicant has determined that there is a problem in which the gap may not be filled correctly with the chemical anchor with existing systems. In particular, there may be an insufficient amount of chemical anchor/filler injected into the gap or, alternatively, there may be an excessive amount of chemical anchor/filler injected into the gap (especially where there may be a void space in communication with the gap).

Examples of the present disclosure seek to provide an improved washer for use in construction anchorage which may avoid or at least ameliorate disadvantages of existing anchorage systems.

### SUMMARY

In accordance with one aspect of the present disclosure, there is provided a washer for filling of an annular gap around a fastener, wherein the washer has a port for filling said gap through the washer, and wherein the washer has an indicator for indicating when said gap has been sufficiently filled.

Preferably, the port is in the form of a first port, and the indicator is in the form of a second port. More preferably, the washer has an upper surface, a lower surface, an outer edge, and an inner edge, and the first port is located in the outer edge. Even more preferably, the first port forms part of a filling conduit which extends from the outer edge to the inner edge.

Preferably, the second port is located in the outer edge. More preferably, the second port forms part of an indicator conduit which extends from the outer edge to the inner edge, arranged to allow passage of filler through the indicator conduit when the gap has been filled sufficiently.

In a preferred form, the indicator is in the form of a channel or groove formed in an upper surface of the washer. Alternatively, the indicator can be in the form of a channel or groove formed in a lower surface of the washer.

It is preferred that the second port has a diameter within the range of 1 mm to 3 mm. More preferably, the second port has a diameter of 2 mm. Even more preferably, the indicator conduit has a diameter of 2 mm.

It is preferred that the port for filling the gap has a diameter within the range of 3 mm to 5 mm. More preferably, the port for filling the gap has a diameter of 4 mm. Even more preferably, the filling conduit has a diameter of 4 mm.

Preferably, the second port is diametrically opposite the first port. More preferably, the indicator conduit is generally in line with the filling conduit.

In accordance with another example of the present disclosure there is provided a method of providing anchorage including the steps of: using an elongated fastener to anchor a first part to a second part; installing a washer as described above; tightening the elongated fastener against the washer; feeding a chemical filler into the port of the washer to fill an annular gap around the elongated fastener; and using the indicator of the washer to determine when to stop feeding of the chemical filler.

### BRIEF DESCRIPTION OF THE DRAWINGS

The present disclosure is described, by way of non-limiting example only, with reference to the accompanying drawings, in which:

FIG. 1 shows a perspective view of an anchorage system using a washer in accordance with an example of the present disclosure;

FIG. 2 shows a side view of the anchorage system of FIG. 1;

FIG. 3 shows a cross-sectional view of the anchorage system of FIG. 1, taken substantially along line A-A shown in FIG. 2;

FIG. 4 shows a cross-sectional view of the anchorage system of FIG. 1 and showing the beginning of injection of chemical anchor/filler through a filler port;

FIG. 5 shows a cross-sectional view of the anchorage system of FIG. 1 and showing flow of the chemical anchor/filler through an indicator port opposite the filler port;

FIG. 6 shows a perspective view of a range of different washer sizes in accordance with the present disclosure;

FIG. 7 shows a top view of the range of different washer sizes, including dimensions;

FIG. 8 shows a side view of one washer in accordance with the present disclosure;

FIG. 9 shows a side view of the range of different washers shown in FIG. 6 and FIG. 7;

FIG. 10 shows a perspective view of an anchorage assembly using a washer in accordance with an example of the present disclosure, at the beginning of chemical anchor injection;

FIG. 11 shows a perspective view of the anchorage assembly of FIG. 10, at an intermediate stage of chemical anchor injection;

FIG. 12 shows a perspective view of the anchorage assembly of FIG. 10, at a complete stage of chemical anchor injection, with flow of chemical anchor through the indicator port; and

FIG. 13 shows a perspective view of the anchorage assembly of FIG. 10, with the chemical anchor further overflowing through the indicator port.

### DETAILED DESCRIPTION

While the features, devices, and apparatus described herein may be embodied in various forms, the drawings show, and the specification describe certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, attached, connected, and the like, are not intended to be limited to direct mounting methods but should be interpreted broadly to include indirect and operably mounted, attached, connected and like mounting methods. This specification is intended to be taken as a whole and interpreted in accordance with the principles of the present disclosure and as understood by one of ordinary skill in the art.

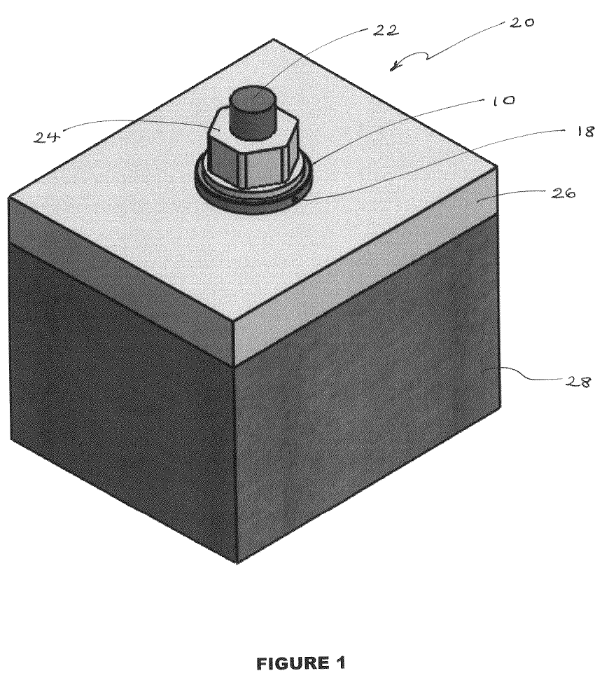

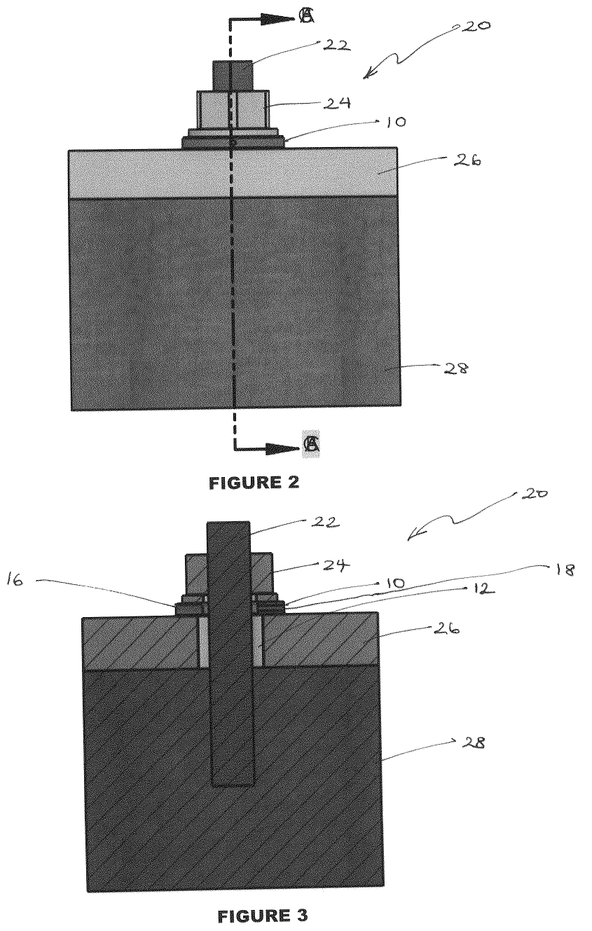

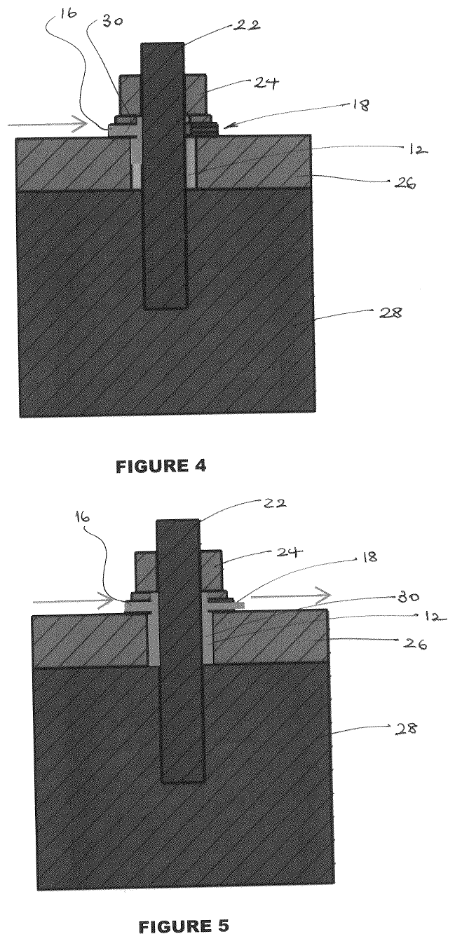

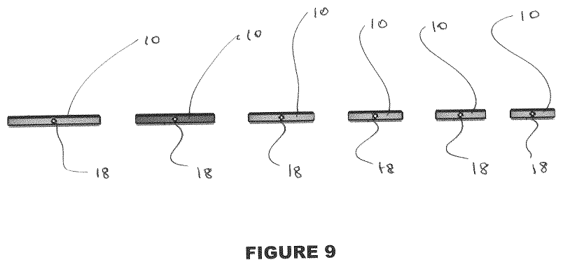

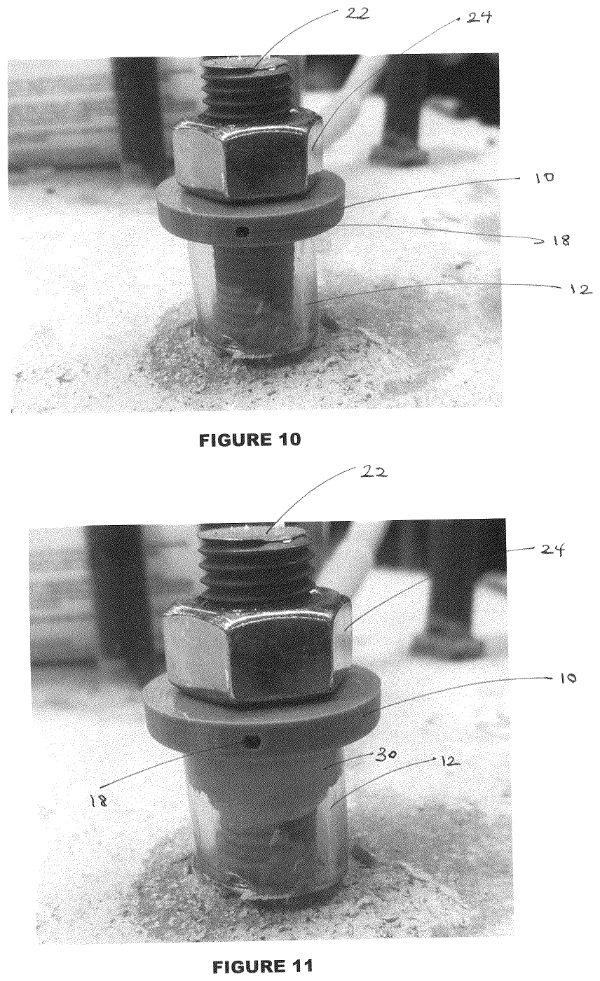

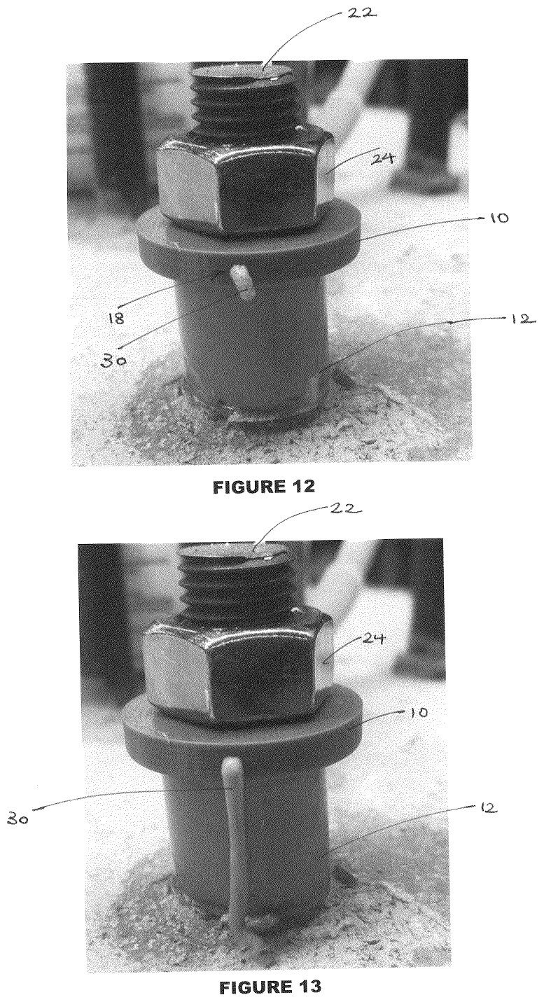

With reference to FIGS. 1 to 13, there is shown a washer 10 for filling of an annular gap 12 around a fastener 14, wherein the washer 10 includes a cylindrical body that has a port 16 for filling said gap 12 through the washer 10, and wherein the washer 10 has an indicator 18 for indicating when said gap 12 has been sufficiently filled. With particular reference to FIG. 1, the washer 10 is used as part of an anchorage assembly 20, also including a threaded elongated fastener 22, a threaded nut 24, a fixture 26 and a substrate 28. The gap 12 is best shown in the cross-sectional views of FIGS. 3 to 5.

Advantageously, the indicator 18 can be in the form of an inspection port which indicates when the annular gap 12 is filled with chemical anchor/filler 30, preventing under filling or overfilling. The overflow chemical anchor/filler material 30 will cure in the inspection port becoming a permanent indicator that the connection has been filled correctly.

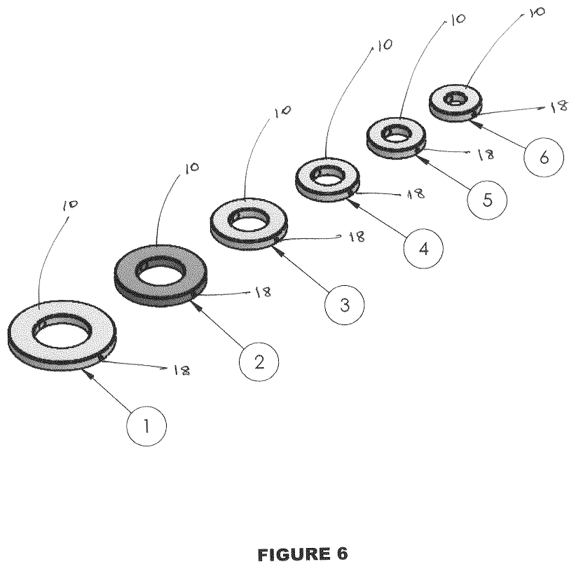

With reference to FIG. 5, the port 16 can be in the form of a first port, and the indicator 18 can be in the form of a second port, opposite the first port 16. The structure of the washer 10 is shown best in FIGS. 6 to 9. As can be seen, the washer 10 has an upper surface, a lower surface, an outer edge (around the outer diameter), and an inner edge (around the inner diameter), and the first port 16 is located in the outer edge. The first port 16 forms part of a filling conduit which extends from the outer edge to the inner edge.

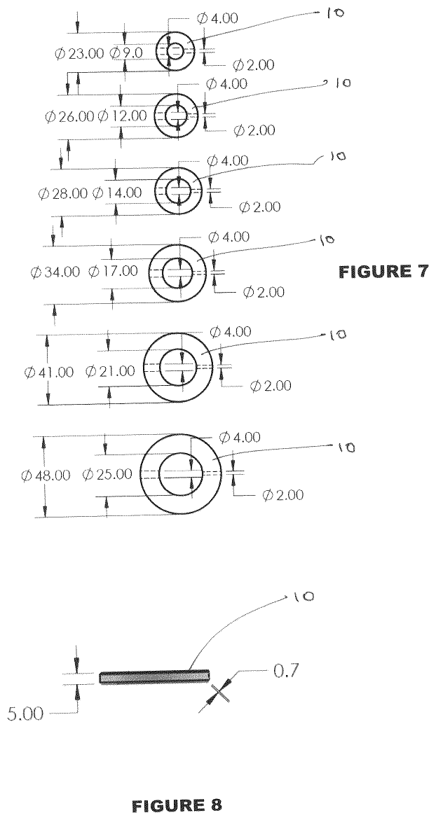

The second port 18 can also be located in the outer edge. In the example shown, the second port 18 forms part of an indicator conduit which extends from the outer edge of the washer 10 to the inner edge of the washer 10, the indicator conduit being arranged to allow passage of filler through the indicator conduit when the gap has been filled sufficiently. As can be seen in the dimensions in FIG. 7, the applicant has determined that, in one example, the second port 18 can have a diameter of 2 mm and the first port 16 can have a diameter of 4 mm.

In an alternative example, not shown, the indicator 18 can be in the form of a channel or groove formed in an upper surface of the washer 10. In yet another example, the indicator 18 can be in the form of a channel or groove formed in a lower surface of the washer 10. The channel or groove can allow radially outward passage of the chemical anchor/filler 30 in a similar manner so as to provide a visual indicator to a user that sufficient feeling of the gap 12 has been achieved.

In one example, the second port 18 can have a diameter within the range of 1 mm to 3 mm. More specifically, the second port 18 can have a diameter of 2 mm so as to provide the correct flow and resistance required for providing an accurate visual indicator at the appropriate stage of filling of the gap 12. The indicator conduit can have a diameter of 2 mm for its whole length from the inner diameter of the washer 10 to the outer diameter of the washer 10.

By way of example only, the port 16 for filling the gap 12 can have a diameter within the range of 3 mm to 5 mm. More specifically, the port 16 for filling the gap 12 can have a diameter of 4 mm. The filling conduit can have a diameter of 4 mm for its whole length from the outer diameter of the washer 10 to the inner diameter of the washer 10.

In the example shown in the drawings, the second port 18 is diametrically opposite the first port 16 to allow crossflow and to provide the most distant path to ensure complete filling of the gap 12. The indicator conduit can be generally in line with the filling conduit.

Accordingly, as will be understood from the above, the washer 10 enables a method of providing anchorage including the steps of: using an elongated fastener 22 to anchor a first part 26 to a second part 28; installing the washer 10 as described above; tightening the elongated fastener 22 against the washer 10; feeding a chemical filler 30 into the port 16 of the washer 10 to fill an annular gap 12 around the elongated fastener 22; and using the indicator 18 of the washer 10 to determine when to stop feeding of the chemical filler 30.

It should be appreciated from the above that the present disclosure also provides a method of providing anchorage including the steps of: using an elongated fastener to anchor a first part to a second part; installing a washer as claimed in claim one; tightening the elongated fastener against the washer; feeding a chemical filler into the port of the washer to fill an annular gap around the elongated fastener; and using the indicator of the washer to determine when to stop feeding of the chemical filler.

While various embodiments of the present disclosure have been described above, it should be understood that they have been presented by way of example only, and not by way of limitation. It will be apparent to a person skilled in the relevant art that various changes in form and detail can be made therein without departing from the spirit and scope of the present disclosure. Thus, the present disclosure should not be limited by any of the above-described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

### LIST OF FEATURES

Washer 10
Annular gap 12
Fastener 14
First port 16
Indicator 18
Anchorage assembly 20
Elongated fastener 22
Threaded nut 24
Fixture 26
Substrate 28
Chemical anchor/filler 30

1. A washer for filling of an annular gap around a fastener, the washer comprising:
a cylindrical body defining:
a port configured to enable the annular gap to be filled through the washer, and
an indicator configured to indicate when the gap has been sufficiently filled.

2. The washer of claim 1, wherein the port is a first port, and the indicator is a second port.

3. The washer of claim 2, wherein the cylindrical body has an upper surface, a lower surface, an outer edge, and an inner edge, and wherein the first port is located in the outer edge.

4. The washer of claim 3, wherein the first port forms part of a filling conduit that extends from the outer edge to the inner edge.

5. The washer of claim 4, wherein the second port is located in the outer edge.

6. The washer of claim 5, wherein the second port forms part of an indicator conduit that extends from the outer edge to the inner edge, the indicator conduit arranged to allow passage of filler through the indicator conduit when the gap has been filled sufficiently.

7. The washer of claim 1, wherein the indicator is in the form of a channel or a groove formed in an upper surface of the cylindrical body.

8. The washer of claim 1, wherein the indicator is in the form of a channel or a groove formed in a lower surface of the cylindrical body.

9. The washer of claim 2, wherein the second port has a diameter within the range of 1 mm to 3 mm.

10. The washer of claim 9, wherein the second port has a diameter of 2 mm.

11. The washer of claim 10, wherein the port is a first port, and the indicator is a second port, wherein the cylindrical body has an upper surface, a lower surface, an outer edge, and an inner edge, and wherein the first port is located in the outer edge, the first port forms part of a filling conduit that extends from the outer edge to the inner edge, the second port forms part of an indicator conduit that extends from the outer edge to the inner edge, the indicator conduit arranged to allow passage of filler through the indicator conduit when the gap has been filled sufficiently, and wherein indicator conduit has a diameter of 2 mm.

12. The washer of any one of claims 11, wherein the first port has a diameter within the range of 3 mm to 5 mm.

13. The washer of claim 12, wherein the first port has a diameter of 4 mm.

14. The washer of claim 13, wherein the filling conduit has a diameter of 4 mm.

15. The washer of claim 14, wherein the second port is diametrically opposite the first port.

16. The washer as claimed in claim 15, wherein the indicator conduit is in line with the filling conduit.

17. The washer of claim 2, wherein the second port is diametrically opposite the first port.

18. A washer for filling of an annular gap around a fastener, the washer comprising:
a cylindrical body having an upper surface, a lower surface, an outer edge, and an inner edge, the cylindrical body defining:
a first port located in the outer edge and extending from the outer edge to the inner edge, the first port configured to enable the annular gap to be filled through the washer, and
an indicator located in the outer edge and configured to indicate when the gap has been sufficiently filled, the indicator including a second port.

19. The washer of claim 18, wherein the second port forms part of an indicator conduit that extends from the outer edge to the inner edge, the indicator conduit arranged to allow passage of filler through the indicator conduit when the gap has been filled sufficiently.

20. The washer of claim 19, wherein the indicator is in the form of a channel or a groove formed in the upper surface or in the lower surface of the cylindrical body.
